(19) United States
(12) Patent Application Publication
(10) Pub. No.: US 2007/0145205 A1
(43) Pub. Date: Jun. 28, 2007

(54) Portable device for laptops

(75) Inventor: Yi-Hsiang Liang, Taichung Hsien (TW)

Correspondence Address: CHARLES E. BAXLEY, ESQ., 90 JOHN STREET, THIRD FLOOR, NEW YORK, NY, 10038, US

(73) Assignees: Yi-Hsiang LIANG (Owners in Common 1/2); Chun-Hsiung Chen (Owners in Common 1/2)

(21) Appl. No.: 11/639,669

(22) Filed: Dec. 15, 2006

(30) Foreign Application Priority Data
Dec. 27, 2005 (TW) 094222749

(51) Int. Cl. F16M 11/32

(52) U.S. Cl. 248/163.1; 361/683

(57) ABSTRACT

A portable device for laptops includes a base with a cover pivotably connected thereto and the base has a space for receiving a laptop therein. Two grooves are defined in an underside of two opposite sides of the base and each groove has two retractable legs received therein. The legs are pivotably and expanded to support the base to form a desk and the laptop is supported by the base.

### FIELD OF THE INVENTION

The present invention relates to a portable device for receiving a laptop, the device includes a box for receiving a laptop therein and foldable legs which are cooperated with the box to form a desk on which the laptop is supported.

### BACKGROUND OF THE INVENTION

A conventional laptop bag generally includes a fabric bag in which the laptop is received and a handle or a strap is connected to the bag so that the user can carry the bag with the laptop. However, when in use, the user has to find a desk or any object with a flat top so as to support the laptop, the bag is then put aside. If no such a flat top can be found, the user usually puts the laptop on his or her legs if the user finds a place to sit, or the laptop is put on the floor. Either way is inconvenient and not suitable for most of the users. Besides, the conventional laptop bag is designed provides a space in the bag to receive the laptop, however, if the laptop is smaller than the bag, then the laptop cannot well positioned in the bag, if the laptop is larger than the bag, the laptop cannot be received in the bag. Furthermore, when using the laptop, some users want to use a mouse which needs a flat area to move, the conventional bag cannot provide such as area for the mouse.

The present invention intends to provide a portable device for laptops and the device includes a box with legs pivotably connected to an underside thereof so as to form a desk and the laptop can be supported on the base of the box.

### SUMMARY OF THE INVENTION

The present invention relates to a portable device for laptops and the device comprises a base and a cover which is pivotably connected to the base which includes a space defined therein so as to receive a laptop. A plurality of grooves are defined in an underside of the base and each groove has at least one leg received therein.

The primary object of the present invention is to provide a portable device which can be transformed into a desk so that the laptop is used on the desk.

Another object of the present invention is to provide a portable device which can be transformed into a desk and a board can be pulled out from a side of the device for the computer mouse.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the portable device of the present invention, wherein the device is in a closed status;

FIG. 2 shows that the device is opened and a laptop is received in the base of the device;

FIG. 3 shows an underside of the device;

FIG. 4 is a cross sectional view along line A-A in FIG. 3;

FIG. 5 shows the legs are expanded from the underside of the base, and

FIG. 6 shows a board is pulled from a side of the base.

### DETAILED DESCRIPTION OF THE PREFERRED EMBODIMENT

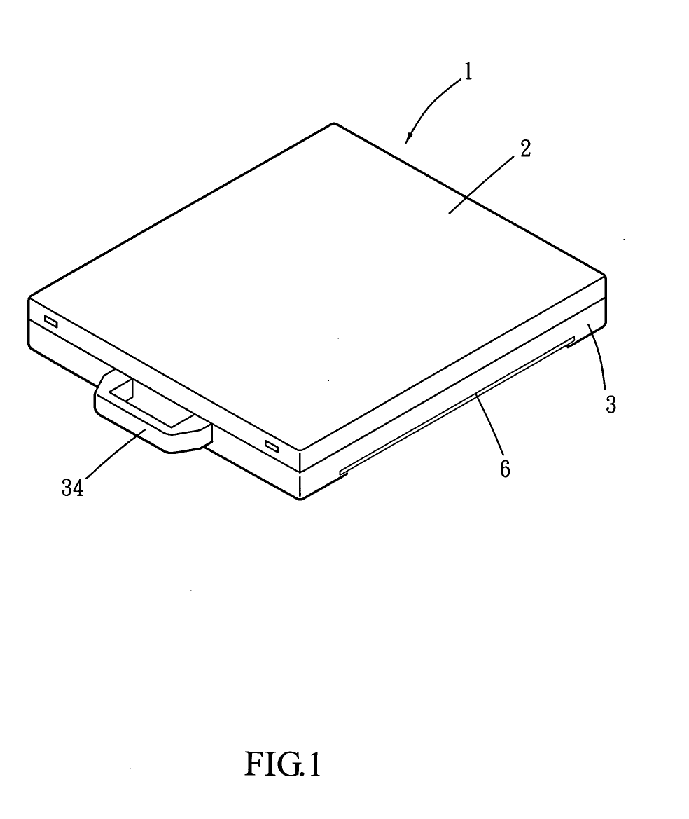

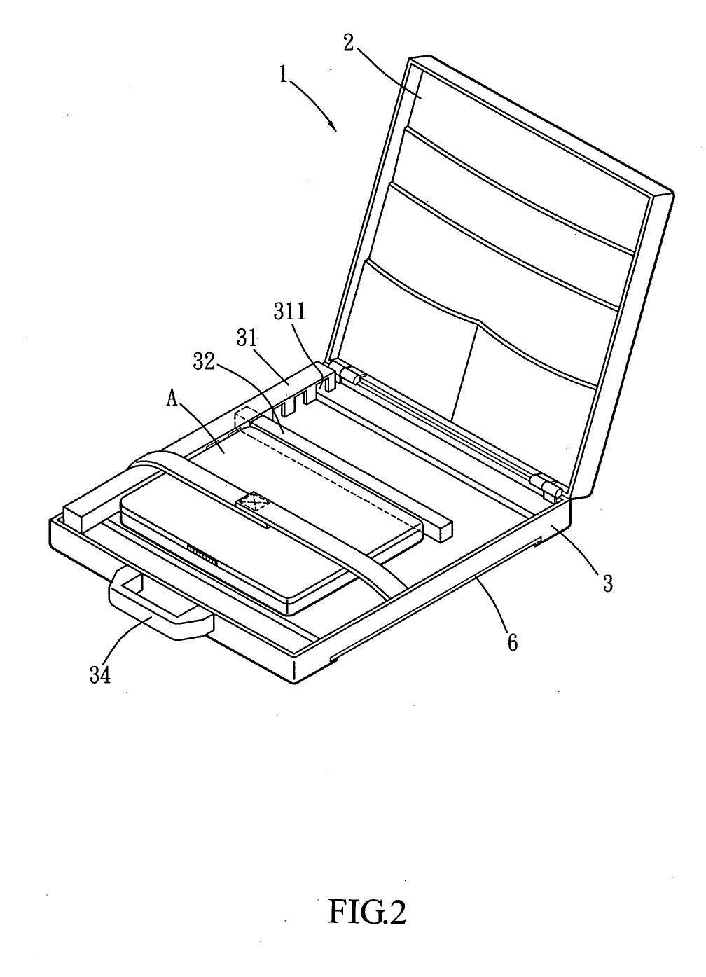

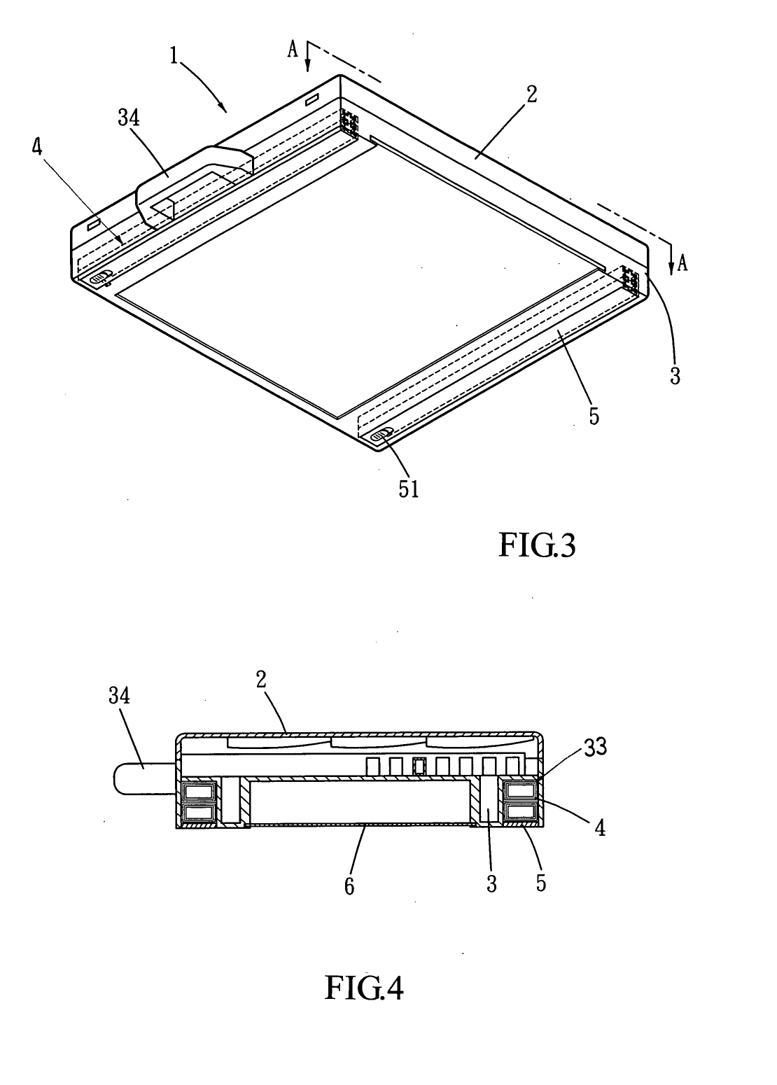

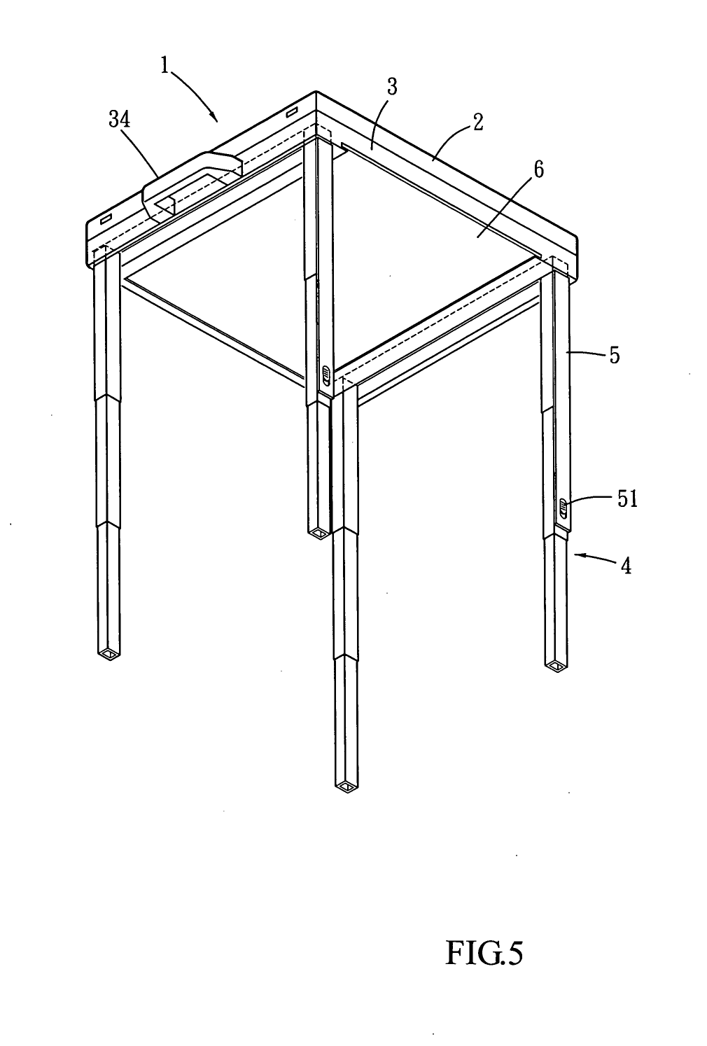

Referring to FIGS. 1 to 4, the portable device 1 of the present invention comprises a box composed of a base 3 and a cover 2 which is pivotably connected to the base 3. A handle 34 is connected to the base 3 for convenience of carry. The base 3 has a space defined therein so as to receive a laptop “A”. A side rod 31 is received in the base 3 and located against an inside of the base 3. The side rod 31 includes a plurality of holes 311 and a positioning bar 32 is removably inserted in one of the holes 311 so as to define an area between the positioning bar 32, the side rod 31 and another inside of the base 3. By positioning the positioning bar 32 in different holes 311 of the side rod 31, the laptop “A” of different size can be well positioned in the base 3.

Two grooves 33 are defined in an underside of the base 3 and located on two opposite sides of the base 3. Two retractable legs 4 are pivotably received in each of the two grooves 33. Each leg 4 includes a cover plate 5 connected thereto which is in flush with the underside of the base 1 when the leg 4 is received in the groove 33 corresponding thereto. A lock device 51 is connected to the cover plate 5 so that the cover plate 5 can be locked to the base 3 and the legs 4 do not drop from the groove 33.

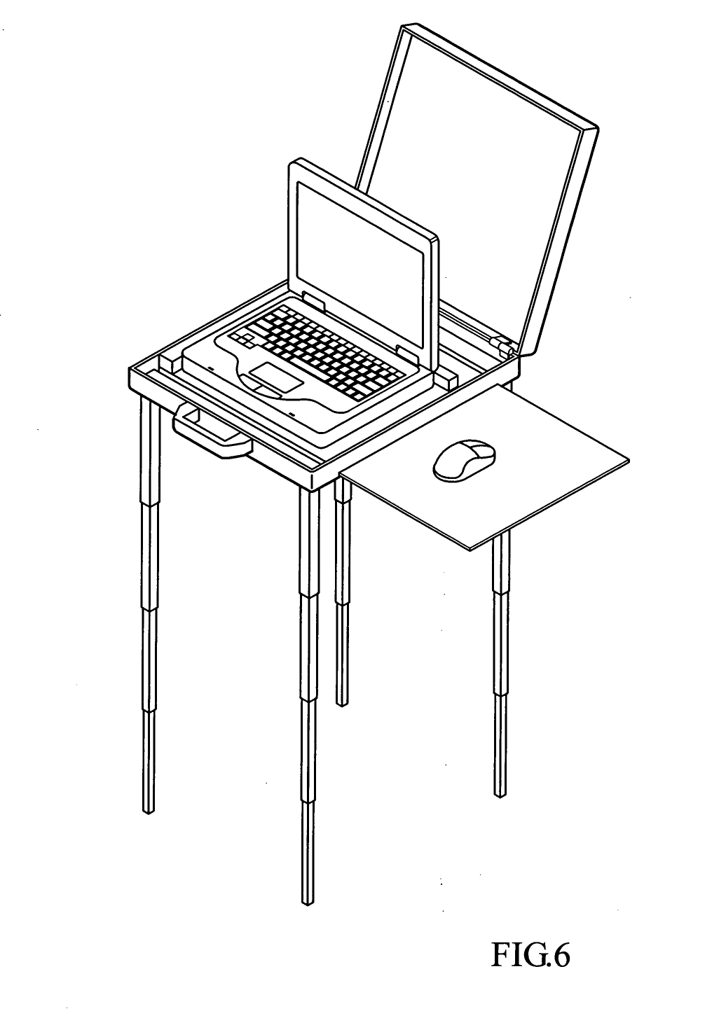

As shown in FIGS. 5 and 6, when in use, the user unlocks the lock devices 51 of the two cover plates 5 and the retractable legs 4 are pivoted outward from the grooves 33 such that the four retractable legs 4 and the box form a desk. The laptop “A” is supported by the base 3. A board 6 is retractably received in a side of the base 3 and can be pull outward for supporting a mouse “B” thereon.

The retractable legs 4 support the box to form a desk when they are pivoted outward from the grooves 33, the desk allows the user to use the laptop “A” comfortably. The four retractable legs 4 are received in the grooves 33 of the base 3 and the cover plates 5 are in flush with the underside of the base 3 so that the box has a flat underside.

While we have shown and described the embodiment in accordance with the present invention, it should be clear to those skilled in the art that further embodiments may be made without departing from the scope of the present invention.

What is claimed is:

1. A portable device for laptops, comprising:
a base and a cover which is pivotably connected to the base, the base having a space defined therein which is adapted to receive a laptop, and
a plurality of grooves defined in an underside of the base and each groove having at least one leg received therein.

2. The device as claimed in claim 1, wherein the grooves are located on two opposite sides of the base and two legs are pivotably received in each of the two grooves.

3. The device as claimed in claim 1, wherein the at least one leg includes a cover plate connected thereto which is in flush with the underside of the base when the at least one leg is received in the groove corresponding thereto.

4. The device as claimed in claim 1, wherein the at least one leg is a retractable leg.

5. The device as claimed in claim 1, wherein a board is retractably received in a side of the base.

6. The device as claimed in claim 1, wherein a side rod is received in the base and located against an inside of the base, the side rod includes a plurality of holes and a positioning bar is removably inserted in one of the holes.
